(19) United States
(12) Patent Application Publication
(10) Pub. No.: US 2021/0261448 A1
(43) Pub. Date: Aug. 26, 2021

(54) Apparatus and Method for Producing Alkaline Water

(71) Applicant: WET HOLDINGS (GLOBAL) LIMITED, Reading (GB)

(72) Inventors: Michael Adams, Knowle, Solihull (GB); Darren Bradley, Knowle, Solihull (GB); Ahmed Mohamed, Birmingham (GB)

(21) Appl. No.: 17/253,407

(22) PCT Filed: Jun. 17, 2019
(86) PCT No.: PCT/GB2019/000084

§ 371 Date: Dec. 17, 2020

(30) Foreign Application Priority Data
Jun. 17, 2018 (GB) 1809909.3

(51) Int. Cl. C02F 1/66; C02F 1/68

(52) U.S. Cl. CPC C02F 1/66; C02F 1/688; C02F 2201/007; C02F 2209/06; C02F 2209/07; C02F 2209/006; C02F 2103/02; C02F 2209/02; C02F 2209/03; C02F 2209/05; C02F 2209/40; C02F 2209/42; C02F 2209/008

(57) ABSTRACT

Apparatus and a method tor the treatment of water includes a vessel (6) having a water inlet (31) and a water outlet (28a, 28b) and means for feeding water to the vessel via the water Inlet. The vessel contains a body of water and a solid particulate or granular material comprising one or more elementary metals or oxides thereof capable of raising the pH of the water. Located within the vessel and connected to the water inlet, is means (32) for causing circulatory motion of water entering the vessel sufficient to suspend the solid material within the body of water during passage of water through the vessel, whereby the pH of the water is caused to He within the range 7 to 11.

### FIELD OF THE INVENTION

The invention relates to apparatuses and methods for treating water, as well as the preparation and formulation of drinks.

### BACKGROUND TO THE INVENTION

Alkaline water is a premium water that has a pH level above 7. It has been reported that consumption of alkaline water provides specific health benefits, including: enhancement of rehydration after exercise, effective hydration during the day, replacement of lost minerals during physical activities and exercise and increased oxygen levels in blood which thereby increases body energy levels. Alkaline water can aid in cancer and diabetes prevention and can aid in treatment of acid reflux as well as providing many other health beneficial effects.

Alkaline water can be categorised into two categories according to production methods: naturally high pH water and artificially enhanced water. Naturally high pH water is sourced from a natural spring or aquifer. It has a naturally high pH level and contains natural minerals. On the other hand, artificially enhanced water is sourced from natural or municipal sources and is then subjected to a form of artificial treatment or processing to increase its mineral content or its pH level. Among the processing methods commonly used for production of artificially enhanced alkaline water are water electrolysis and chemicals addition.

Alkaline water electrolysis is a type of water electrolysis that is characterised by having two electrodes immersed in a liquid electrolyte solution (e.g. sodium hydroxide or potassium hydroxide, etc) and being separated by a diaphragm to separate the product gases and transport the hydroxide ions (—OH) from one electrode to another. This method requires chemicals to be present in solution and the passing of electrical current through the electrodes to conduct electricity. As a result, acidic water accumulates in one side of the electrolyser, while alkaline water accumulates on the other side of the electrolyser which enables the operator to syphon the acidic water out while collecting the alkaline water.

Recently, chemicals, such as synthetic magnesium oxide medium or calcium carbonate or soda have been used to produce alkaline water. Naturally or municipally sourced water is caused to flow through a filter that is filled with calcium carbonate or synthetic magnesium oxide medium. The materials dissolve in the water and raise its pH level.

These processes suffer from a number of limitations and disadvantages including running costs, use of electricity, production of waste water, unsustainable use of chemicals and the chemical and physical properties of the end product particularly the instability of pH levels of water produced by electrolysis. Also, a number of research studies indicate that consumption of electrolysed alkaline water may be linked to ailments such as cancer and cardiovascular system pathologies.

Traditionally, drinks are made with water, sugar/sweeteners, flavouring agents, solubilizers, stabilizers, and other ingredients. During drinks production, mains water is first filtered using a high-pressure process called reverse osmosis (RO) to remove organic and inorganic constituents to comply with regulatory standards. However, this water is chemically aggressive and has an acidic pH of 6.1 and a TDS of 0.3 mg/I. Once formulated, soft drinks have a pH of 2.5 (strong acid) which is detrimental to body tissues and organs. Also, large quantities of sugars/sweeteners are added to counteract the bitter taste produced by the added flavours. However, sugars/sweeteners in soft drinks have been linked to a number of medical and health conditions such as diabetes, obesity, high blood pressure and cardiac and renal conditions. For instance, according to Eurostat data, 51.6% of the adult population (≥8 year old) within EU-28 are considered over-weight (44.7% of female and 59.1% male populations) in 2015. Obesity has been estimated to cost the EU €70 billion annually through healthcare costs and lost productivity. The European Association for the Study of Obesity (EASO) found direct obesity-related costs ranging from 1.5-4.6% of health expenditure in France to around 7% in Spain. There are forecasts that suggest that if European governments devoted all existing and future resources allocated to weight management to the most cost-effective approaches, they could save up to 60% in some European countries.

Further health concerns from soft drink consumption are related to: tooth decay (caries) as a result of the high acidity and high sugar content; increased blood pressure from the overconsumption of fructose with 20.5% of the EU-28 population (≥15 year old) self-reporting hypertension in 2015 (21% of female and 20% male populations); heartburn (or Gastroesophageal Reflux Disease GERD) from the highly acidic nature of soft drinks with 9-20% of Europeans suffer from GERD in 2016 (equally prevalent in females and males); and harmful effects on the liver. In the long-term, there is risk for non-alcoholic fatty liver disease with prevalence of 23.7% in Europe in 2018 (no consensus among researchers on gender differences) and kidney damage with 10% of the European population suffering from Chronic Kidney Disease (CKD) due to the acidity nature and radical mineral imbalances. It has been reported that CKD stages G3-G5 are more prevalent in females. Further, in energy sports drinks consuming acidic liquids can exacerbate the build-up of lactic acid and hence impede athlete performance. Based on a typical 227 litres of soft drink consumption per capita, this equates to ˜15.89 kg in-take of sugar. A modest overall sugar reduction of target of 50% in drinks would equate to 7.945 kg less sugar or 30,747 kcal p.a. (based on 387 kcal/100 g sugar). This will help reduce the health issues cited above.

Unfortunately, adjusting the pH of RO water to alkaline using ion exchange and/or electrolysis processes is not achievable. As mentioned above, the latter methods are unable to maintain a stable pH as there is no reserve alkalinity. Also, the addition of alkaline solutions to RO water causes salt precipitation and flavour spoiling.

It would be beneficial to be able to produce alkaline water, at commercially large quantities that meet market demands of the beverages industry, which is also stable and able to withstand the addition of formulations, flavourings and other ingredients without turning into acidic water. Also, it would be advantageous to monitor and control quality and key performance indicators such as pH, conductivity and impurity level of water during the production of this stable alkaline water. This is important for the elimination of added sugars and sweeteners which would help tackle the ailments associated with high levels of sugars and artificial sweeteners in commercial soft drinks.

### STATEMENTS OF THE INVENTION

The present invention is concerned with a novel water treatment and drink formulation method and apparatuses in which commercial and large volumes of stable alkaline water are produced by treating purified water by a non-magnetic, suspended agitation process (n-MSAP) inside mineral manipulation chambers in a system [termed: Activated Enhancement System (AES)] comprising a single module or an assembly of multiple modules.

According to the present invention, there is provided apparatus for the treatment of water, the apparatus comprising a vessel having a water inlet and a water outlet, means for feeding water to the vessel via the water inlet, the vessel containing a body of water and a solid particulate or granular material comprising one or more elementary metals or oxides thereof capable of raising the pH of the water, and means, located within the vessel and connected to the water inlet, for causing circulatory motion of water entering the vessel sufficient to suspend the solid material within the body of water during passage of water through the vessel, whereby the pH of the water is caused to lie within the range 7 to 11.

The non-magnetic suspended agitation process (n-MSAP) takes place inside the vessel, which is, or which includes, the mineral manipulation chamber whereby inlet purified water comes in contact with the reaction medium which preferably that comprises up to 17 elementary metals and/or their oxides including calcium, potassium, sodium, manganese, zinc, magnesium, germanium, iron, zinc, copper, chromium, cobalt, nickel, boron, vanadium, molybdenum and selenium and combinations of these elements with each other and with other elements. The reaction of the inlet flowing water with the suspended reaction medium causes the pH of the water to lie within the range from 7 to 11.

The reaction of the inlet water with the reaction medium by the n-MSAP inside the said mineral chambers is monitored and controlled by elements of the apparatus. The apparatus is manufactured from food grade materials.

The apparatus is designed to ensure intimate contact between the inlet purified water with the reaction medium by continuously suspending and circulating the inlet purified water with the reaction medium by mineral suspension devices and with the aid of external pumps and valves. The said mineral suspension devices cause the water inside the chamber to move in circulatory motion to facilitate and maintain effective suspension of the reaction medium within the body of the inlet water.

The apparatus may comprise one or more vessels and the or each vessel and its associated equipment may constitute a module. Each module may be provided with a plurality of reaction performance and water quality probes including, but not limited to, pH probes, conductivity probes, temperature probes, water flow rate probes and others. These devices monitor the reaction of the inlet purified water with the said reaction medium, optimize the n-MSAP and ensure that the quality of the outlet product alkaline water meets the commercial criteria including, but not limited to, the pH level, TDS level, temperature and volumes of alkaline water produced.

Preferably, an individual AES module may comprise a module vessel housing a mineral manipulation chamber, external tanks, external pumps, valves, reaction probes, a control panel, a field control box, a mounting framework, media exchange box and 0.2 μm filtration cartridge.

The vessel may be provided with openable lids at the top and bottom ends. Both lids may be fixed to the said vessel by lockable tri clamps. The top lid may be provided by holes through which tubes project. A sealing gasket is provided around each hole.

The vessel may be bolted onto an external mounting framework and may be connected to external water pipes by a tube, located at the top lid, through which inlet feed purified water is caused to flow into the mineral manipulation chamber with the aid of a mineral suspension device and a series of external pumps and valves. Preferably, eductor nozzles may be utilized as the mineral suspension devices.

Preferably, the inlet feed water is purified to TDS levels below 75 ppm upstream of the module vessels by a filtration system.

An individual module may be provided with a plurality of water quality probes which are installed at different key points/locations within the modules including, but not limited to, conductivity probes, pH meter probes, water pressure probes and water temperature probes.

The flow rate of the inlet feed water may be monitored and controlled by a control panel. The control panel comprises a PLC and receives input feed from the plurality of water quality probes via the field control boxes. These probes may be installed inside the water pipework at key processing points/locations including, but not limited to, before the external pumps and before and after the said module vessels. The control panel is equipped with a digital display touch screen that shows the input feed data from the probes. Also, the control panel is provided by PLC that is programmed with an algorithm that computes the data input feed from the probes to control and maintain the reaction conditions and to produce water at the desired chemical and physical properties.

Alternatively, the operator can also adjust the flow rate of the inlet feed water in case of emergency.

The reaction medium may be poured manually into the vessel through the upper lid or through a media prescription system that can be installed at the top end of the said vessel.

An individual module may be capable of treating a flow rate of 50-150 litres/min of inlet purified water. Larger volumes of inlet water may be treated by adding more modules in an assembly. By way of example, 16 modules can be set up in a configuration to treat a cumulative water throughput of 2400 litres/min.

By way of example, an individual module treating a water throughput of 50-150 litres/min, a vessel may have a footprint of approximately 1.5 m (L)×1.5 m (VV)×2.5 m (H).

The lid at the bottom of the vessel may be provided with a hole through which a tube projects. At the end of the tube, a locked butterfly valve may be fixed to allow for controlled manual or emergency disposal of reaction water and reaction medium.

The vessel may also be provided with holes on its sides through which collection tubes extend to external water pipework that connect with outlet water collection tanks. The holes may be provided with gasket sealing.

The collection tubes may be equipped with automatically controlled external valves to regulate the flow rate of the outlet water exiting the vessel and therefore regulate the level of water inside the mineral manipulation chamber. The valves may be connected to the control panel via the control field box. The algorithm may automatically control the said valves. Also, the operator may adjust the valve by input on the control panel.

Preferably, the lid at the top of the vessel is provided with water level probes which are installed at water level gauge to monitor the level of the water inside the said mineral manipulation chamber. The input feed from the water level gauge is sent to the control panel via the control field box. If the level of the water inside the mineral manipulation chamber exceeds the highest permissible level, the control panel PLC sends a signal to the external valve to increase the flow rate of the outlet alkaline water exiting the vessel.

Following the reaction inside the mineral manipulation chamber, the outlet alkaline water (pH 7 to 11) exits the said vessel and then flows into outlet water collection tanks via the said collection tubes by gravity. The flow rate of the exiting outlet alkaline water can be regulated automatically by the external valve as described above.

The collection tubes may be equipped with plurality of water quality probes to monitor the quality of the outlet alkaline water exiting the vessel. This includes, but not limited to, conductivity probes, temperature probes and pH meter probes. The probes are connected to the control panel via the control field box.

The PLC is equipped with software that is programmed with the algorithm to control and maintain ideal reaction processing conditions. The algorithm processes input feed data from the said probes in addition to input data from the amount of the proprietary reaction media inside the mineral manipulation chamber and other key reaction variables. It also considers the desired chemical and physical properties of the produced outlet water.

The control panel is equipped with display touch screen to facilitate monitoring and control of the module or modules in assembly by the operator. The said display touch screen provides readings from the input feed data from the plurality of probes installed in the module.

The outlet alkaline water exiting the AES apparatus is collected in water collection tanks which can then be pumped indirectly into bottling line installation or soft drink production facilities by storing in holding tank. Alternatively, the AES apparatus may provide a retrofitted technology that is capable of easy and direct installation into a bottling line installation or soft drink production facilities.

An individual module may be equipped with an integrated antitampering system. The antitampering system may detect and prevent any attempt to remove and access the module vessel, any module components, and the removal of the suspended proprietary reaction media by unauthorised persons, whilst allowing for its servicing by an authorised service engineer. The antitampering system may comprise a plurality of lockable tri clamps, visual detectors and other devices.

The anti-tampering visual detectors are installed at any point in the modules and are provided with in-built batteries, memory and facilities to remotely connect to display platform via remote SIM connectivity technology.

An individual module may be provided by a safety battery backup UPS system to protect the module from brown-outs and black-outs.

An individual module may be provided by manual override so that, when changing the suspended proprietary reaction media or any module component, a service engineer can stop the flow.

An individual module may be provided by a CIP system which has the potential to require manual intervention to ensure that, whatever reagent is used for cleaning, it is topped up or refreshed either as a matter of cleanliness or as the suspended reaction media loses potency.

Utilising a telemetry system, once a certain propriety media threshold is reached, an ‘alert’ email may be sent to the system operator giving advance notice that the suspended reaction media may require replacement. If it is not replenished then, once the threshold of potency is reached, another email is sent to inform that the suspended reaction medium has not been replenished, and that the system may shut down, and require manual over-ride.

Once manual over-ride has been activated the service level agreement (SLA) may be nullified, and a service engineer may have to come to replenish and reset before the SLA can come back into effect. In addition to the alert emails, an alarm coded light system may light up on the unit to inform that the service interval is about to be breached. To override the shut-down, an ‘authority’ key, RFID tag, or code—perhaps via email or a customer area of the web-site, and utilizing the telemetry system—needs to be sent. This ensures that only the appropriate people, who can authorize the costs associated and accept liability for running without CIP, can override the shut-down and break the SLA.

An assembly comprising a plurality of individual AES modules may be configured to treat larger flow rate of inlet feed water (>150 litres/min). By way of example, 5 modules may be set up in configuration to treat 750 litres/minute of inlet feed water.

In the said assembly of multiple modules in a configuration, the inlet feed water may be pumped into a manifold to distribute the inlet feed water to the modules. The manifold may be installed upstream of the external pumps in each of the modules in the configuration.

Preferably, the inlet feed water may be purified to TDS levels below 75 ppm upstream of the manifold by a filtration system.

In the assembly of multiple modules, a manifold may be installed in the water pipework upstream of the outlet water collection tank. This is to collect the outlet alkaline water produced by each module in the configuration and direct it to the water collection tanks.

In the said assembly of multiple modules, a single control panel may monitor and control the performance of up to 16 modules in the configuration. The control panel may receive input feedback from the control field box (in each individual module in the assembly).

The control panel, in an individual module or in an assembly of multiple modules, may provide wireless feedback to remote control station to facilitate remote monitoring and control of the module or modules in operation.

At the bottling line or drinks production facilities, the outlet alkaline water may be bottled/packaged under strict production and bottling/packaging conditions to produce bottled/packaged plain alkaline water with pH ranging from 7 to 11. Alternatively, the outlet alkaline water may be mixed with drink formulations under strict production and bottling/packaging conditions at bottling line or drinks production facilities to produce drinks including, but not limited to, flavoured alkaline water, soft drinks, flavoured drinks, functional beverages, protein rich drinks and sports drinks.

Additionally, the outlet alkaline water may be mixed with drink formulations under strict production and bottling/packaging conditions at bottling line or drinks production facilities to produce drinks with no or reduced added sugar and artificial sweeteners.

### BRIEF DESCRIPTION OF THE DRAWINGS

The accompanying drawings are as follows:

FIG. 1A is a diagrammatic view of the instrumentation and piping of a single module AES apparatus of the present invention;

FIG. 1B is a diagrammatic two-dimensional view of the single module AES apparatus of FIG. 1A;

FIG. 2A is a perspective view of an AES vessel of the apparatus of FIG. 1A;

FIG. 2B are elevational views of the AES vessel of FIG. 2A;

FIG. 2C are elevational views of the AES vessel of FIG. 2A mounted on an external metal framework;

FIG. 3A is a longitudinal section of an AES vessel of the apparatus of FIG. 1;

FIG. 3B is a longitudinal section of a device within the vessel of the apparatus of FIG. 1 which causes circulatory motion of the water entering the vessel;

FIG. 3C is a diagrammatic view of a device similar to that of FIG. 3B but showing it attached to radially inwardly directed water inlet of a vessel;

FIG. 4 is a diagrammatic view of remote monitoring and control apparatus for use in a single module AES apparatus of the invention;

FIG. 5A is a diagrammatic view of an AES apparatus of the invention having two AES modules in configuration with instrumentation and piping;

FIG. 5B is a side elevation of the apparatus of FIG. 5A; and

FIG. 6a-c are diagrammatic views of remote monitoring and control apparatus of the apparatus of FIGS. 5A and 5B.

### DETAILED DESCRIPTION OF THE INVENTION

The invention will now be described, by way of examples only, with reference to the accompanying drawings.

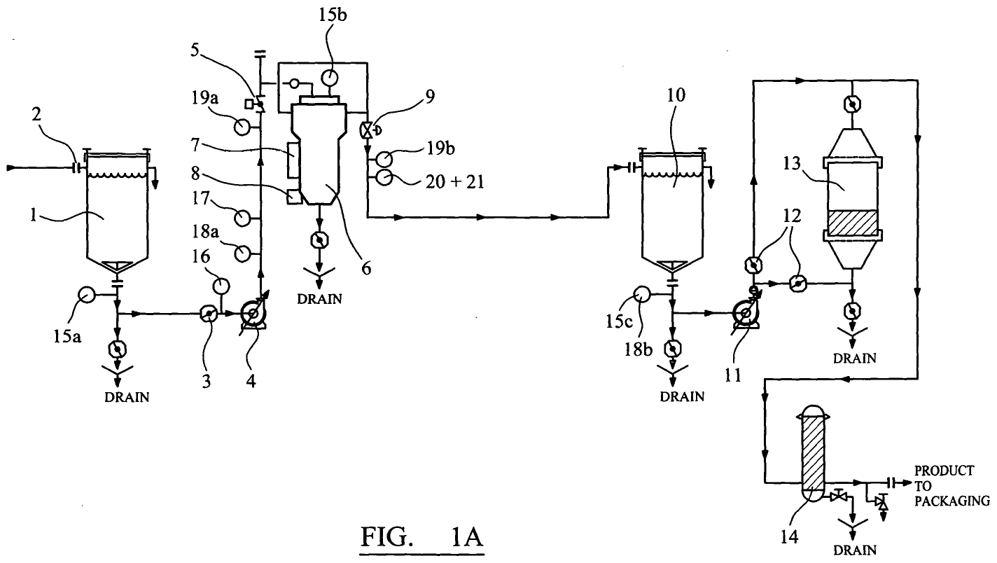

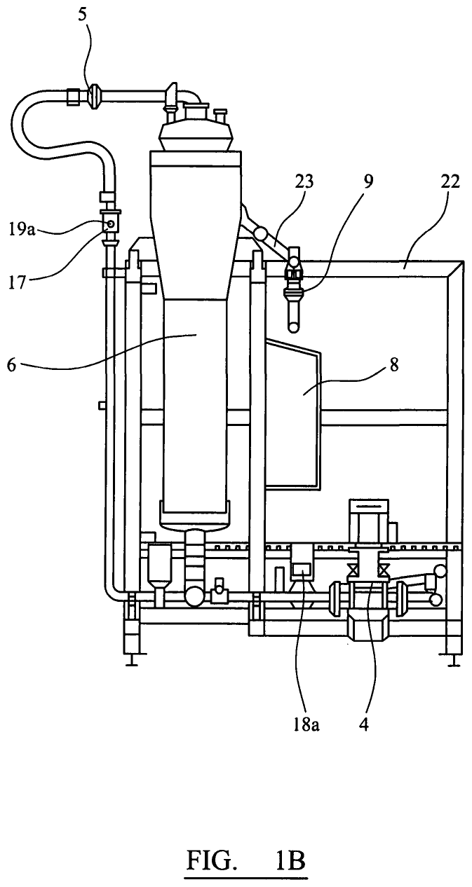

Referring to FIG. 1A and FIG. 1B of the accompanying drawings, an AES apparatus of the invention consists of a single module comprising a tank for inlet feed water 1, a manual butterfly valves 2 and 3, an external pump for inlet feed water 4, automatic butterfly valve 5, an AES module vessel 6, a control panel 7, a field control box 8, a modular diaphragmatic valve 9, an tank for outlet water 10, an external pump for outlet water 11, an external mounting framework 22, manual butterfly valves 12, a media exchange box 13, a filtration cartridge 14 and the pipework that connects the apparatus to the bottling plant's machinery and also connects the components of the apparatus itself.

The components of the apparatus that are in direct contact with water are manufactured from food grade materials.

The apparatus includes a plurality of water quality probes: water pH probe 20, water conductivity probes 19a-b, water pressure probes 18a-b, water flow meters probe 17, water temperature probe 21, water presence probe 16 and water level probes 15a-c as shown in FIGS. 1A and 1B. These are to monitor the flow of the water passing through the apparatus and to monitor and control the quality of both the inlet feed water and outlet produced water.

The water quality probes are connected to the field control box 8 via cables which are connected to the control panel 7 which is provided by a PLC. Control panel 7 receives the data feed generated by the water quality probes and facilitates the demonstration and monitoring of the data feed via a digital display touch screen that shows the input feed data from the water quality probes.

The inlet feed water tank 1 is supplied by water through the manual butterfly valve 2. The water is sourced from a spring or a river or borehole or any other natural sources or alternatively is supplied by the bottling plant following water purification by reverse osmosis (RO) treatment. The TDS of the inlet RO purified water is 75 ppm.

The external pump 4 and valves 3 and 5 cause the water to flow from the inlet feed water tank 1 through the pipework and into the module vessel 6 where treatment by the non-magnetic suspended agitation process (n-MSAP) takes place which causes the pH of the water to lie between 7-11. The path of the water passing through the apparatus is represented by the direction of the arrows in the accompanying figures.

The non-magnetic suspended agitation process (n-MSAP) takes place when the inlet water comes in contact with the reaction medium that comprises elementary metal and/or oxides of 17 elements including calcium, potassium, sodium, manganese, zinc, magnesium, germanium, iron, zinc, copper, chromium, cobalt, nickel, boron, vanadium, molybdenum and selenium and combinations of these elements with each other and with other elements. The reaction of the inlet flowing water with the suspended reaction medium causes the pH of the water to lie within the range from 7 to 11.

The parameters of the n-MSAP may be set-up by the operator including, but not limited to, desired pH levels and desired flow rate via the said control panel 7. The flow of the inlet feed water may be controlled and maintained automatically by the said reaction algorithm or manually by an input from the operator via the digital touch screen of the said control panel 7 by adjusting the flow rate of the inlet feed water by changing the pressure of the external pumps 4.

The control panel 7 may provide wireless feedback to a remote control station to facilitate remote monitoring and control of the AES module in operation.

This single module apparatus is capable of treating a flow rate of 50-150 litres/min of inlet water. Larger volumes of inlet water can be treated by adding more modules to the apparatus. By way of example, 16 modules may be set up in a configuration to treat a cumulative water throughput of 2400 litres/min.

The vessel 6 of this single module apparatus has a footprint of approximately 1.5 m (L)×1.5 m (W)×2.5 m (H).

Following the treatment of the inlet water by the n-MSAP inside the vessel 6, the outlet alkaline water (pH 7 to 11) exits the vessel 6 and then flows into outlet water tank 10 through collection tubes 23 by gravity. The flow rate of the exiting outlet alkaline water may also be regulated automatically by the said modular diaphragmatic valve 9, via input feed from a water level probe 15b installed at a water level gauge, and the PLC inside the control panel 7.

The collection tubes 23 are equipped with an automatically controlled modular diaphragmatic valve 9 to regulate the flow rate of the outlet alkaline water exiting vessel 6 and therefore to regulate the level of water inside the vessel. The valve 9 is connected to the control panel 7 via the control field box 8. The operator may also adjust the valve by input on the control panel 7 in case of emergency.

As shown in FIG. 1A, the alkaline produced water inside the outlet water tank 10 may then be caused to flow by external outlet water pump 11 into a media exchange box 13 which houses the reaction medium that activates and maintains the pH of the outlet alkaline water and provided by internal enzymatic agitator to further clean the outlet alkaline water. The outlet alkaline water may then be fed into a 0.2 μm filter 14 to remove any particulates. Alternatively, the alkaline produced water inside the outlet water tank 10 may be caused to flow directly into the 0.2 μm filter 14, bypassing the media exchange box 13 via a manual butterfly valve 12.

As shown in FIG. 1A, the apparatus is connected indirectly to the bottling plant through a holding tank where the alkaline water from the outlet is stored for subsequent bottling/packaging. Alternatively, the AES machine could be retrofitted to the bottling plant machinery through which the alkaline water is delivered directly to the bottling plant for bottling/packaging.

An individual module may be equipped with an integrated antitampering system. The antitampering system may detect and prevent any attempt to remove or access the module vessel 6, any module components, and the removal of the suspended proprietary reaction media by unauthorised persons, whilst allowing for its servicing by an authorised service engineer. The antitampering system may comprise plurality of lockable tri clamps and visual detectors.

An individual module may be provided with a safety battery backup UPS system to protect the module from brown-outs and black-outs.

An individual module may be provided by a manual override so that, when changing the suspended reaction medium or any module components, a service engineer can stop the water flow.

An individual module may be provided with a CIP system which has the potential to require manual intervention to ensure that, whatever reagent for cleaning, is topped up or refreshed either as a matter of cleanliness or as the suspended reaction media loses potency.

Utilising a telemetry system, once a certain reaction medium threshold is reached an ‘alert’ email may be sent to the system operator giving advance notice that the suspended reaction medium may require replacement. If it is not replenished then, once the threshold of potency is reached, another email is sent to inform that the suspended reaction medium has not been replenished, and that the system may shut down, and require manual over-ride.

Once manual over-ride has been activated the Service Level Agreement (SLA) may be nullified, and a service engineer may have to come to replenish and reset before the SLA can come back into effect. In addition to the alert emails, an alarm coded light system may light up on the unit to inform that the service interval is about to be breached. To override the shut-down, an ‘authority’ key, RFID tag, or code needs to be sent, perhaps via email or a customer area of the web-site, and utilizing the telemetry system. This ensures that only the appropriate people, who can authorize the associated costs and accept liability for running without CIP, can override the shut-down and break the SLA.

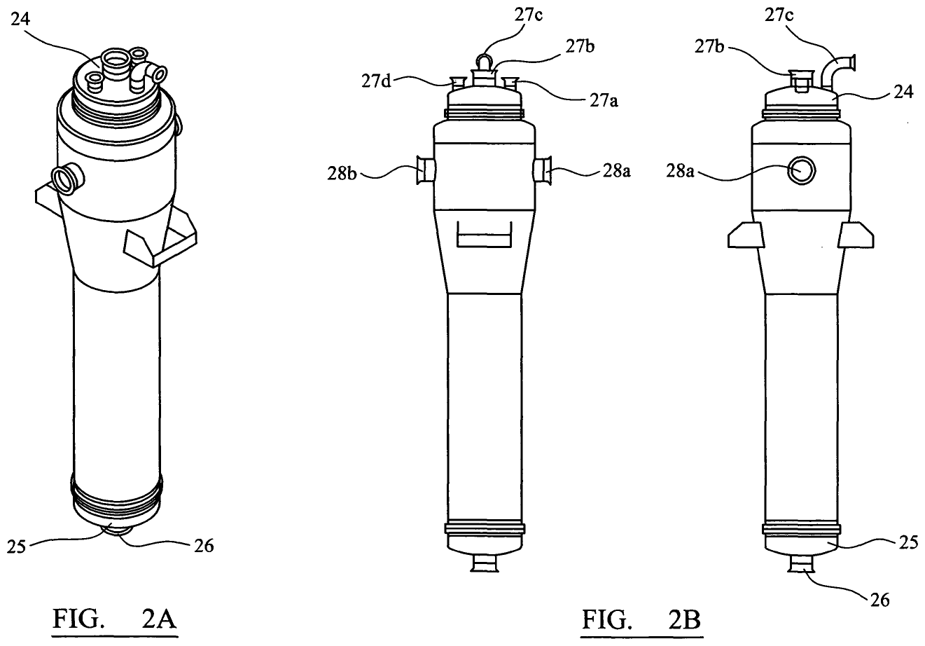

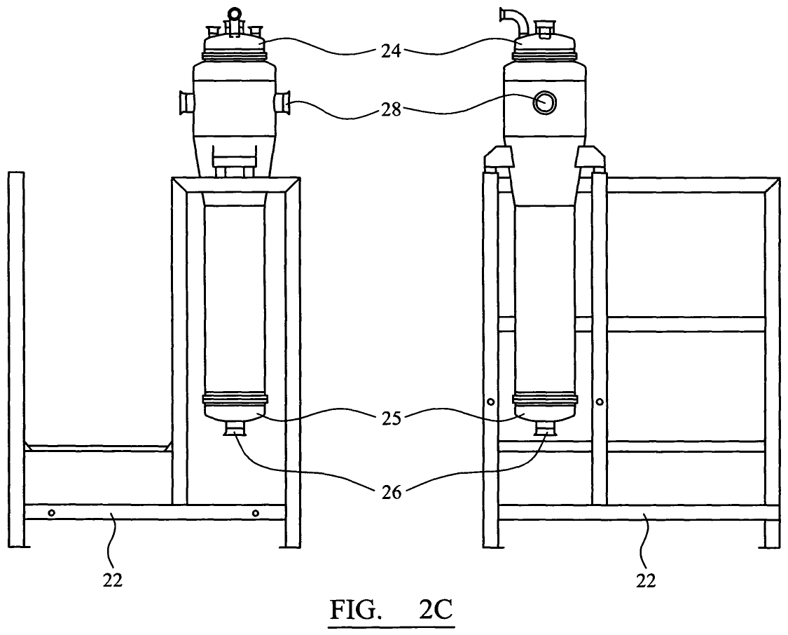

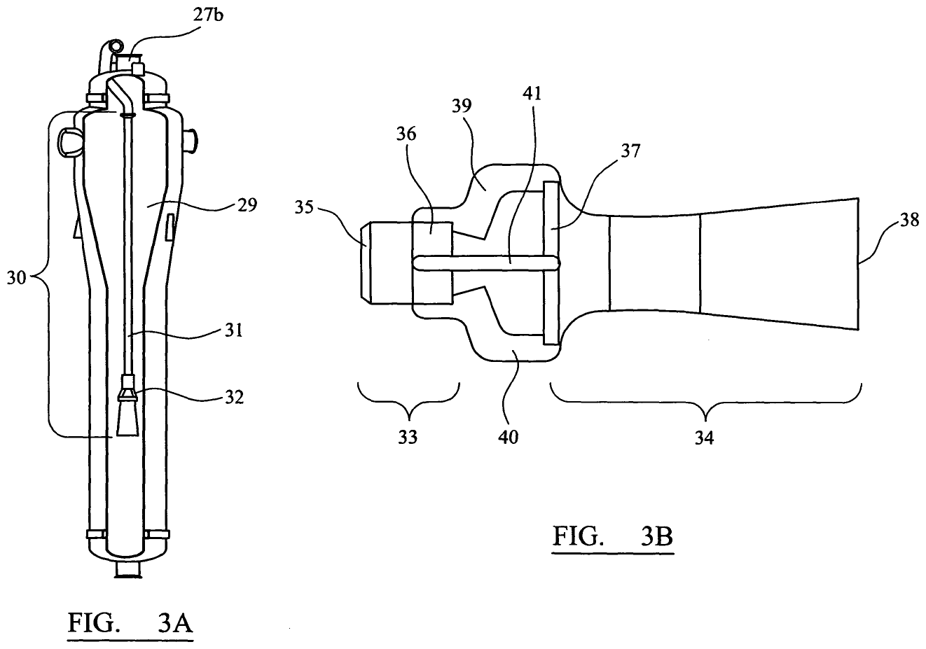

Referring to FIGS. 2A, 2B and 2C of the accompanying drawings, the vessel is tubular in shape and may be bolted into an external mounting framework 22. The vessel houses a mineral manipulation chamber whereby inlet flowing water is treated by the said non-magnetic suspended agitation process (n-MSAP).

The vessel is provided with openable lids 24 and 25 on the top end and bottom end respectively. Both are fixed to the vessel by lockable tri clamps.

The bottom lid 25 of the vessel is provided with a hole through which a tube 26 projects. At the end of the tube, a locked butterfly valve may be fixed to allow for controlled manual or emergency disposal of reaction water.

The top lid 24 is provided with holes 27a, b and d through which tubes may project. A sealing gasket is provided around each hole. The top lid 24 is connected to external water pipes by a curved tube 27c through which inlet feed water may be caused to flow into the mineral manipulation chamber with the aid of a mineral suspension device and a series of external pumps and valves.

The reaction medium is poured manually into the said AES module vessel through the upper lid via the tube 27b. Alternatively, the reaction medium may be poured into the vessel through a media prescription system that may be connected to mineral suspension device via the curved tube 27c.

The vessel 6 may also be provided on its side with holes 28a and b through which collection tubes extend to external water pipework that connect with the outlet water tank. The holes are provided with gasket sealing with in-built filters to avoid reaction medium escapes.

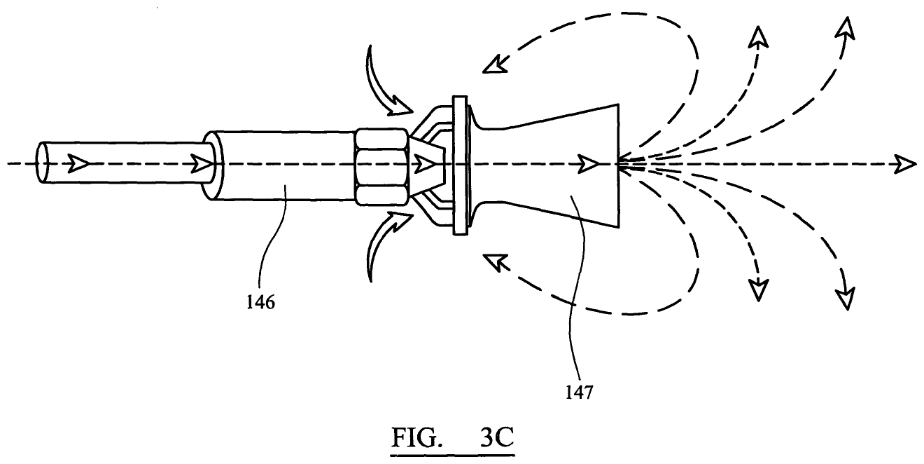

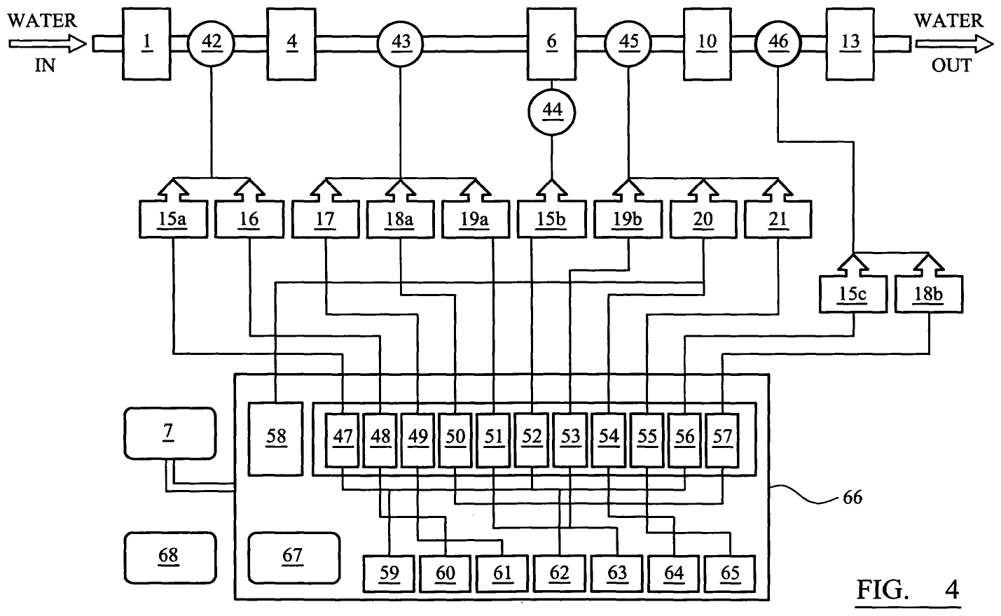

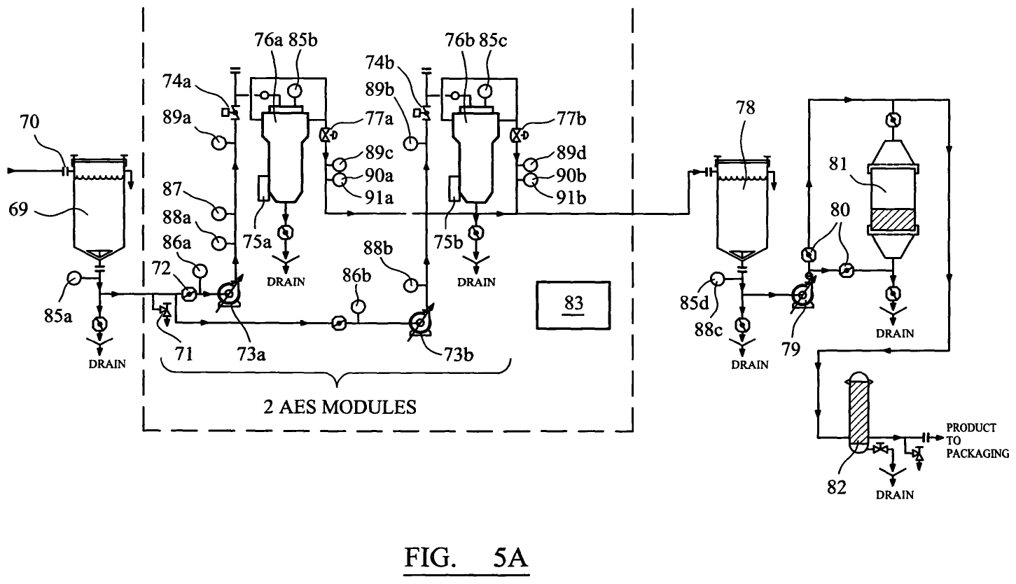

Referring to FIGS. 3A and 3B of the accompanying drawings, vessel 6 comprises a mineral manipulation chamber 29, in which the non-magnetic suspended agitation process (n-MSAP) takes place, as well as a mineral suspension device 30, and a water level gauge.

The mineral manipulation chamber 29 houses the reaction medium which comprises up to 17 elementary metal and/or their oxides including calcium, potassium, sodium, manganese, zinc, magnesium, germanium, iron, zinc, copper, chromium, cobalt, nickel, boron, vanadium, molybdenum and selenium and combinations of these elements with each other and with other minerals. The reaction of the inlet flowing water with the suspended reaction medium causes the pH of the water to lie within the range from 7 to 11.

The mineral manipulation chamber 29 is provided a mineral suspension device 32 that continuously pumps the inlet flowing water into the said mineral manipulation chamber 29, causes the inlet water to move in a circulatory motion and suspends the reaction medium within the circulatory moving inlet water. This is to ensure effective suspension of the reaction medium in the circulating inlet flowing water and to maintain intimate contact with the suspended proprietary reaction media inside the said chamber.

The mineral manipulation device 30 comprises 2 compartments: a pipe 31 and a water circulator embodiment 32 and is connected to the external inlet feed water pump through pipework and is manufactured of food grade materials including food grade stainless steel.

The water circulator embodiment 32 is welded to the end of the pipe 31. The embodiment 32 comprises a discharge orifice 33 component and a venturi section 34 component. The embodiment 32 draws in surrounding fluid as water passes through the embodiment and results in, typically, the amount of water being set in motion within the chamber being five times that of the water actually entering the chamber.

The discharge orifice 33 may comprise a male projection section 35 and a nozzle 36. The male projection section connects the discharge orifice 36 into the inlet pipe 31 and facilitates delivery of pumped inlet water under the influence of the pressure of the external inlet water pump.

The venturi section 34 has a semi-rectangular shaped body with an upper vent 37 and a lower vent 38. The venturi section is connected to the discharge orifice component via connecting ribs 39-41.

The water circulator embodiment 32 is 20-24 cm in height and has a maximum width of 9.8 cm. The diameter of the lower vent 38 may be of 5.5 cm.

The inlet water is pumped through the discharge orifice 36, under the influence of the external inlet water pump pressure, and into the venturi section 34. After filling the mineral manipulation chamber with inlet flowing water, the inlet water continues to pump through the discharge orifice 33 and into the venturi section 34. The jet of pumped water enters the venturi section 34 taking additional water from the surrounding body of water inside the mineral manipulation chamber 29 via the upper vent 37 and moving it through the venturi. A discharge plume of combined water pumped from the discharge nozzle 36 and water taken from the mineral manipulation chamber exits the venturi through the lower vent 38 which causes the body of water to move in a circulatory motion. This enables effective and continuous suspension of the elements of the reaction medium within the body of the inlet water while maintaining intimate contact between the inlet flowing water with the reaction medium.

Alternatively, an eductor nozzle 147 may be fitted to a radially inwardly directed end of inlet pipe 146 as illustrated in FIG. 3C. The water flow is indicted by arrows in this diagram.

Software is programmed to a reaction algorithm to establish and control ideal reaction processing conditions during the n-MSAP. The software is installed into the PLC and processes input feed data from the said plurality water quality probes in addition to input data including, but not limited to, the amount of the proprietary reaction media inside the mineral manipulation chamber 29, the chemical and physical properties of the elementary metals and/or their oxides included in the propriety reaction media. The reaction algorithm also considers target duration of water processing and the chemical and physical properties of target outlet alkaline water including, but not limited to, pH, TDS, temperature, volume and flow rate.

The lid 24 at the top of the vessel 6 may also be provided with a water level probe installed at the water level gauge to monitor the level of the water inside the mineral manipulation chamber 29. The input feed from the water level probe may then be sent to the said control panel via the said control field box. If the level of the water inside the mineral manipulation chamber exceeds the highest permissible level set-up by the operator, the said control panel PLC sends a signal to the said external automatic diaphragmatic valve to increase the flow rate of the outlet alkaline water exiting the vessel 6.

Referring to FIG. 3C of the accompanying drawings, there is illustrated an alternative arrangement in which inlet 146 has an end section turned radially inwardly so that eductor 147 directs water radially inwardly. Water flow into and through the eductor is shown by arrows in this drawing.

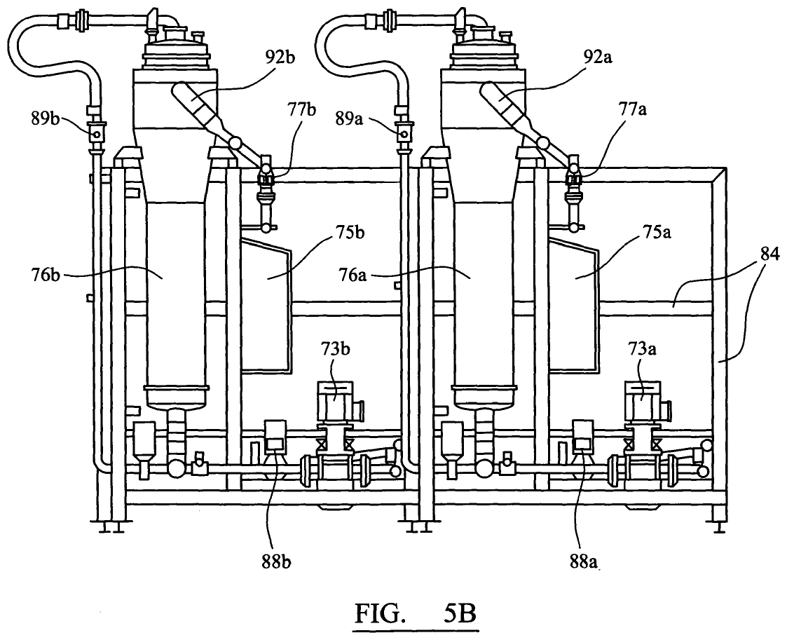

Referring to FIG. 4 of the accompanying drawings, there is illustrated apparatus for the continuous control and monitoring of AES apparatus comprising a single module in accordance with the present invention. This apparatus may continuously measure and monitor the water pH, conductivity, temperature, water levels, water presence and flow rates of water passing through the components of the apparatus. The apparatus may comprise five testing points: the first testing point 42 is located between the inlet feed tank 1 and the external inlet water pump 4; the second testing point 43 is located upstream of the vessel 6; the third testing point 44 is located inside the vessel 6; the fourth testing point 45 is located downstream of the vessel 6; and the fifth testing point 46 is located between the outlet water tank 10 and the media exchange box 13.

The testing points comprise pH meter probe 20, flow meter probe 17, water pressure probes 18a-b, water level probes 15a-c, conductivity probes 19a-b, water temperature probe 21 and water presence probe 16. The probes are connected via cables to transmitters which are located in field box 66 (item 8 in FIGS. 1A and 1B). The transmitters are connected to a data logger epi-sensors 46-57 which send data via cables to the control panel 7. The transmitters also send data via radiowave to a gateway 67 which in turn sends the data to an online control and monitoring platform 68.

The data information from the water pressure probes 18a-b, flow meter probe 17, water pH probe 20 and temperature probe 21 are sent to the control panel 7 via the field box 66 to aid the operator directly adjust the flow rate to maintain the desired pH of the outlet alkaline water. Alternatively, the algorithm may also maintain and control the desired pH of the outlet alkaline water automatically by adjusting the pumps and valves of the apparatus.

The data information on water temperature, pH, conductivity, flow rate, pressure and water levels may be displayed locally or remotely. Data may be sent to the control panel 7 as described above. Also, data may be sent to local service engineers via texts on their mobile phones. Alternatively, data may be sent to a local or remote control room where information may be analysed and any issues addressed. Information may be relayed using, for instance, conventional cables, on-line techniques or satellite communications. Messages may be sent to local service engineers via tests on their mobile phones.

When the reaction medium inside the AES module vessel is no longer able to produce outlet water to the desired pH level, additional reaction medium may be poured manually via the holes in the top lid of the vessel 6, as described above.

As described previously, the apparatus may be equipped with anti-tampering measures including, but not limited to, visual detectors and lockable tri-clamps. The anti-tampering visual detectors are installed at any point between the first and the fifth testing stations or at any other AES machine componentry. The visual detectors may have in-built batteries, internal memory and may also be able to send visual feed remotely through SIM card technology.

An assembly comprising of plurality of modules may be set up in a configuration to treat a larger flow rate of inlet feed water (>150 litres/min). By way of example, 5 modules can be set up in configuration to treat up to 750 litres/minute of inlet feed water.

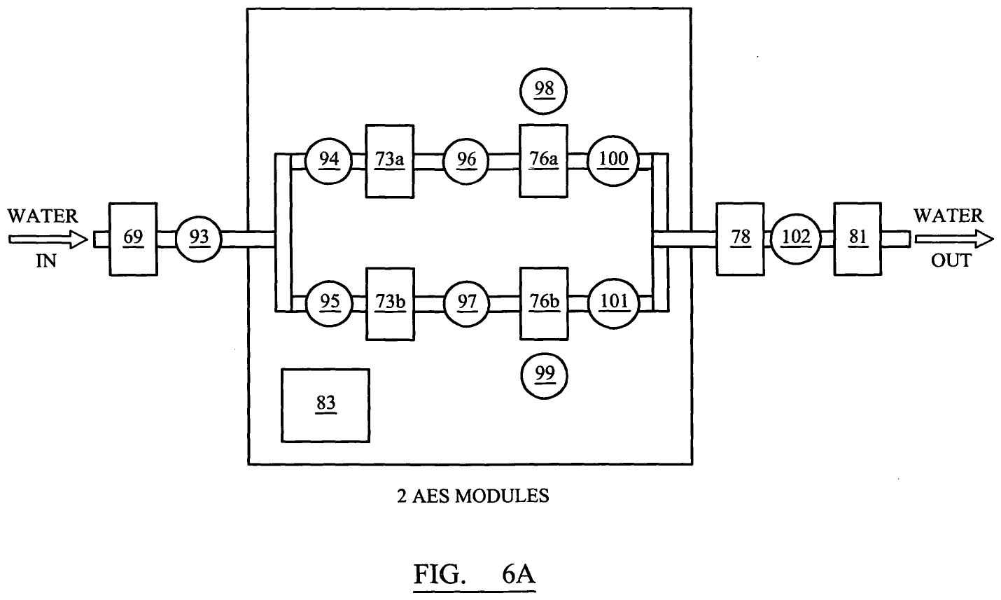

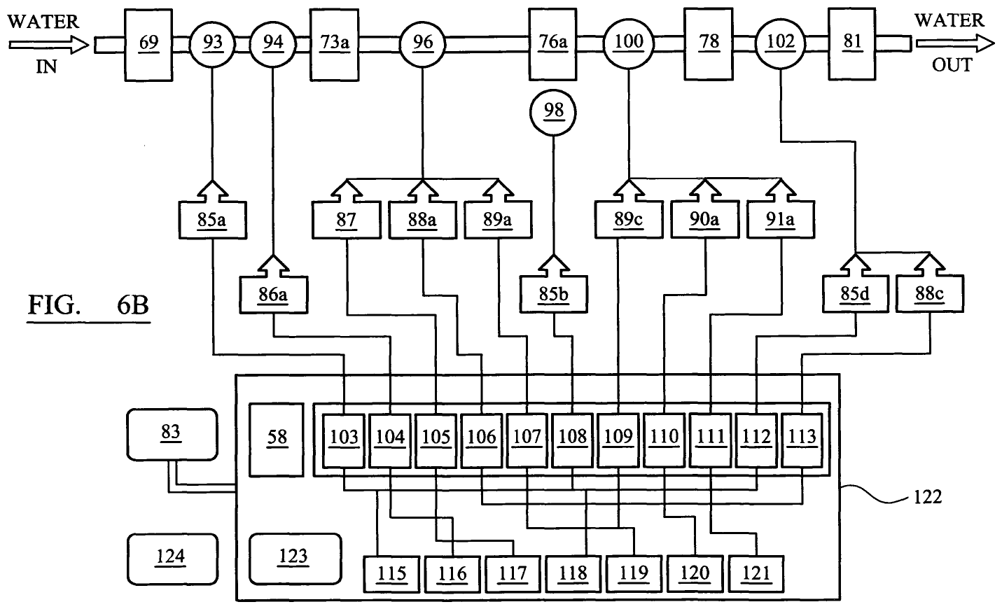

Referring to FIGS. 5A and 5B of the accompanying drawings, there is illustrated a configuration of two modules. The inlet feed water from the external inlet feed water tank 69 is caused to flow into the two modules via a manifold and an auto-bleed valve 71. The manifold and the auto-bleed valve 71 may be installed upstream of the external pumps 73a and 73b in each of the modules.

The inlet feed water may be purified to TDS levels below 75 ppm upstream of the external inlet feed water tank 69 by reverse osmosis (RO) or any other filtration process, in a similar manner to that described in connection with the apparatus of FIGS. 1-4.

Following the distribution of the inlet feed water by the manifold and auto-bleed valve 71, external inlet water pumps 73a and 73b cause the water to flow into each AES module vessels 76a and 76b. Each AES module requires a separate external inlet water pump. By way of example, an AES apparatus having five AES modules requires five external inlet water pumps.

The apparatus of FIGS. 5A and 5B includes an external inlet feed water tank 69, manifold and auto-bleed valve 71 in addition to the components included in each AES module. These include manual butterfly valves 86a and 86b, external pumps for inlet feed water 73a and 73b, automatic butterfly valves 74a and 74b, AES module vessels 76a and 76b, a control panel 83, field control boxes 75a and 75b, modular diaphragmatic valves 77a and 77b, a tank for outlet water 78, external pump for outlet water 79, an external mounting framework 84, manual butterfly valves 80, a media exchange box 81, a 0.2 μm filtration cartridge 82 and the pipework that connects the AES machine componentry to the bottling plant's machinery and also connects the AES machine components thereof.

The design, structure and operation of the AES module vessels 76a and 76b are similar to that of the AES module vessel described in connection with the apparatus of FIGS. 1-4.

As with the AES apparatus of FIGS. 1-4, the n-MSAP takes place inside the mineral manipulation chambers of the vessels 76a and 76b whereby the inlet feed water comes in contact with the reaction medium which cause the pH of the water to lie between 7 and 11.

The inlet feed water is caused to flow through the components of the apparatus, from the external inlet feed water tank 69 to the bottling plant's machinery, with the aid of the pumps and valves. The path of the flowing water passing through the apparatus is presented by the direction of the arrows in FIGS. 5A and 5B.

The components of the apparatus of FIGS. 5A and 5B that are in direct contact with water are manufactured with food grade materials.

Each AES module is provided with plurality of performance and water quality probes including, but not limited to, water pH probes 90a-b, water conductivity probes 89a-d, water pressure probes 88a-c, water flow meter probe 87, water level probes 85a-d, water presence probes 86a-b and water temperature probes 91a-b. This is to monitor the flow of the water passing through the apparatus and to monitor and control the quality of both the inlet feed water and outlet produced water.

The water quality probes are connected to the field control boxes 75a and 75b via cables which in turn are connected via cables to the control panel 83 which is provided by a PLC. The control panel 83 receives the data feed generated by the water probes and facilitates the demonstration and monitoring of the data feed via a digital display touch screen that shows the input feed data from the said water quality probes.

A single control panel may monitor and control the performance of up to 16 modules in configuration. Thus, in FIGS. 5A and 5B, the control panel 83 controls and monitors the two AES modules. For apparatus having more than 16 AES modules, an additional control panel may be added to control and monitor up to 16 additional AES modules.

Similar to the apparatus of FIGS. 1-4, the control panel 83 comprises a PLC, software and a display touch screen. The software is programmed with an algorithm that automatically controls and maintains the performance of the apparatus. The software computes the data information received from the plurality of the said probes in addition to other key reaction variables and the desired outlet water production quality.

The flow of the inlet feed water may also be controlled and maintained by a manual input from the operator via the digital touch screen of the said control panel 83 by adjusting the flow rate of the inlet feed water accordingly.

Following the treatment of the inlet water by the n-MSAP inside the said AES module vessels 76a and 76b, the outlet alkaline water (pH 7 to 11) exit the vessels and then flows into outlet water tank 78 through collection tubes 92a and 92b by gravity. This is to collect the outlet alkaline water produced by each module and to ensure flow of the outlet alkaline water into the external outlet water tank 78.

The flow rate of the exiting outlet alkaline water may be regulated automatically by the said modular diaphragmatic valves 77a and 77b. The collection tubes are equipped with automatically controlled modular diaphragmatic valves to regulate the flow rate of the outlet alkaline water exiting the AES module vessels 76a and 76b and thereby regulating the level of water inside the said AES module vessels. The valves 77a and 77b may be connected to the control panel 83 via the control field box 75a and 75b. The operator can adjust the said valves by input on the control panel 83 in case of emergency.

The outlet alkaline produced water inside the outlet water tank 78 is caused to flow by external outlet water pump 79 into a media exchange box 81 to activate and maintain the pH of the outlet water and then is caused to flow into a 0.2 μm filtration cartridge 82 to remove any particulates. Alternatively, the outlet alkaline produced water inside the outlet water tank 78 may be caused to flow directly into the 0.2 μm filter 82, bypassing the media exchange box 81 via a manual butterfly valves 80.

Preferably, the media exchange box 81 houses the reaction medium to activate and maintain the pH level of the water within the range from 7 to 11. It also comprises internal enzymatic probes to further clean and purify the outlet alkaline water.

The apparatus is connected indirectly to the bottling plant through a holding tank where the outlet produced alkaline water is stored for subsequent bottling/packaging.

Alternatively, the apparatus could be retrofitted to the bottling plant machinery through which the outlet produced alkaline water is delivered directly to the bottling plant for bottling/packaging. The path of the flowing water passing through the apparatus is indicated by the arrows shown in FIG. 5A.

An integrated antitampering system may be provided. The antitampering system may detect and prevent any attempt to remove or access the said AES module vessels 76a and 76b, any assembly components, and the removal of the suspended proprietary reaction media by unauthorised persons, whilst allowing for its servicing by an authorised service engineer. The antitampering system may comprise plurality of lockable tri clamps and visual detectors.

Each individual AES module may be provided by a safety battery backup UPS system to protect the module from brown-outs and black-outs. Also, an individual AES module may be provided by manual override so that, when changing the suspended proprietary reaction media or any module componentry, a service engineer can stop the water flow.

The apparatus may be provided by a CIP system which has the potential to require manual intervention to ensure that the reaction medium is topped up or refreshed either as a matter of cleanliness or as the suspended reaction media loses potency.

By utilising a telemetry system, once a certain propriety media threshold is reached, an ‘alert’ email may be sent to the system operator giving advance notice that the suspended reaction media may require replacement. If it is not replenished then, once the threshold of potency is reached, another email is sent to inform that the suspended reaction media has not been replenished, and that the system may shut down, and require manual over-ride.

Once manual over-ride has been activated the Service Level Agreement (SLA) may be nullified, and a service engineer may have to come to replenish and reset before the SLA can come back into effect. In addition to the alert emails, an alarm coded light system may light up on the unit to inform that the service interval is about to be breached. To override the shut-down, an ‘authority’ key, RFID tag, or code—perhaps via email or a customer area of the website, and utilizing the telemetry system—needs to be sent. This ensures that only the appropriate people, who can authorize the costs associated and accept liability for running without CIP, can override the shut-down and break the SLA.

At the bottling line or drinks production facilities, the outlet alkaline water is bottled/packaged under strict production and bottling/packaging conditions to produce bottled/packaged plain alkaline water with pH ranging from 7 to 11.

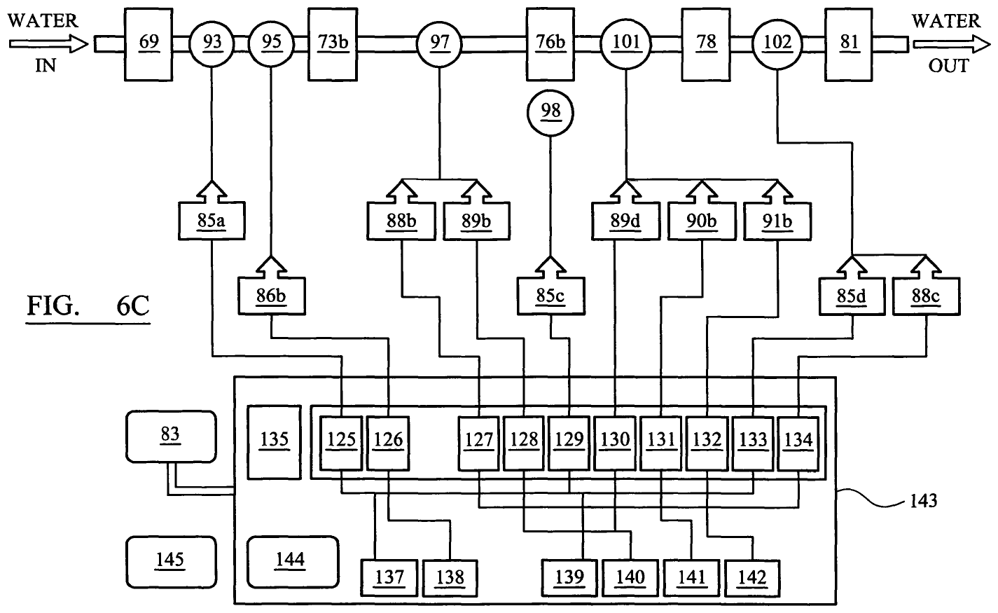

Referring to FIGS. 6A, 6B and 6C of the accompanying drawings, there is illustrated apparatus for the continuous control and monitoring of AES apparatus comprising two AES modules. This apparatus may continuously measure and monitor the water pH, conductivity, temperature, water levels water pressure, water presence and flow rates of water passing through the AES assembly componentry in configuration. The apparatus may comprise six testing points: one testing point 93 is located between the inlet feed tank 69 and the external inlet water pumps 73a and 73b; and four testing points 94-101 are located in each AES module in the assembly and one testing point 102 which is located between the outlet water tank 78 and the media exchange box 81.

The testing points comprise pH meter probes 90a-b, flow meter probe 87, water pressure probes 88a-c, water level probes 85a-d, conductivity probes 89a-d, water presence probes 86a-b and water temperature probes 91a-b. The probes may be connected via cables to transmitters which are located in the field boxes 122 and 143 (items 75a and 75b in FIG. 5A) of each AES module. The transmitters are connected to a data logger epi-sensors 103-113 and 125-134 which may send data via cables to the control panel 83. The transmitters also send data via radiowave to gateways 123 and 144 which in turn send the data to an online control and monitoring platforms 124 and 145.

The data information from the water pressure probes 88a-c, flow meter 87, water pH probes 90a-b and temperature probe 91a-b are sent to the control panel 83 via the field boxes 122 and 142 to aid the operator adjust the apparatus manually to the desired pH of the outlet alkaline water by adjusting the inlet flow rate, as described previously. This may also be achieved automatically by the reaction algorithm which computes the data input feed from the probes to automatically control and maintain the reaction condition within the apparatus by adjusting the components of the apparatus as described previously.

The data information on water temperature, pH, conductivity, flow rate, pressure, presence and water levels may be displayed locally or remotely. Data may be sent to the control panel as described above. Also, data may be sent to local service engineers via texts on their mobile phones. Alternatively, data may be sent to a local or remote control room where information may be analysed and any issues addressed. Information may be relayed using, for instance, conventional cables, on-line techniques or satellite communications. Messages may be sent to local service engineers via tests on their mobile phones.

When the reaction medium is no longer able to produce outlet water to the desired pH level, additional reaction medium may be poured manually via the holes in the top lid of each AES module vessel, as described previously. Alternatively, additional reaction medium is added with the aid of media prescription systems which may be connected to each vessel 76a and 76b through their respective upper lids.

As described previously, the apparatus is equipped with anti-tampering measures including, but not limited to, visual detectors and lockable tri-clamps. The anti-tampering visual detectors are installed at any point between the first and the sixth testing stations or at any point within the AES assembly componentry. The said visual detectors may be provided by in-built batteries, data memory and may also be connected online via SIM connectivity.

Following the delivery of the outlet alkaline water to the bottling plant's machinery, the outlet alkaline water is bottled/packaged under strict production and bottling/packaging conditions to produce bottled/packaged plain alkaline water with stable pH ranging from 7 to 11.

The outlet alkaline water produced by the n-MSAP in the present invention had been chemically analysed for water potability by using state of the art chemical and microbial analytical methods including Inductively Coupled Plasma Optical Emission Spectrometry (ICP-OES), Inductively Coupled Plasma Mass Spectrometry (ICP-MS), Metrohm Compact Ion Chromatography (Metrohm Compact IC), and Proton Nuclear Magnetic Resonance (¹H-NMR). The outlet alkaline water has also been analysed for microbial contamination by using a range of standardised and state of the art microbial contamination methods. Both the chemical and microbial analysis tests were conducted by independent certified and accredited laboratories. The results of water potability tests of the outlet alkaline water produced by bringing water purified by reverse osmosis (RO) filtration in contact with the reaction medium inside the apparatus of the invention are as follows:

| Test description | Result | Units |
|---|---|---|
| Hydrogen ion (pH) | 10.5 | pH units |
| Conductivity | 59.7 | μS/cm |
| Turbidity | 0.15 | NTU |
| Colour | <1.0 | mg/l Pt/Co |
| Ammonium ammonia + ammonium ions | 0.032 | mg/l |
| Nitrite as NO₂ | <0.002 | mg/l |
| Nitrate as NO₃ | <0.37 | mg/l |
| Chloride as Cl | 0.7 | mg/l |
| Aluminium, Total as Al | <7.22 | μg/l |
| Calcium, Total as Ca | <0.31 | mg/l |
| Iron, Total as Fe | <0.700 | μg/l |
| Magnesium, Total as Mg | 8.43 | mg/l |
| Manganese, Total as Mn | 0.87 | μg/l |
| Sodium, Total as Na | 0.90 | mg/l |
| Arsenic, Total as As | <0.08 | μg/l |
| Cadmium, Total as Cd | <0.013 | μg/l |
| Nickel, Total as Ni | <0.09 | μg/l |
| Solids, Dissolved 180 Deg C. | 34 | mg/l |
| Hardness, Total as CaCO₃ | 35.0 | mg/l |
| Magnesium Hardness as CaCO₃ | 34.6 | mg/l |
| Total Organic Carbon | <0.14 | mg/l |
| Total Oxidised Nitrogen as NO₃ | <0.30 | mg/l |
| Hardness, Total as Ca | 14.0 | mg/l |
| Copper, Total as Cu | <0.6 | μg/l |
| Lead, Total as Pb | 0.02 | μg/l |
| Zinc, Total as Zn | 4.8 | μg/l |
| Sulphur, Total as SO₄ | <0.25 | mg/l |
| Alkalinity as CaCO₃ | 28.4 | mg/l |
| Alkalinity as HCO₃ | 34.7 | mg/l |
| Langelier Index | −0.72 | n/a |
| Total Coliforms Confirmed | 0 | CFU/100 ml |
| E. coli Confirmed | 0 | CFU/100 ml |
| Total Coliforms Presumptive | 0 | CFU/100 ml |
| E. coli Presumptive | 0 | CFU/100 ml |
| TVC 22° C. 3 day | 0 | CFU/100 ml |
| TVC 27° C. 2 day | 0 | CFU/100 ml |
| Enterococci confirmed | 0 | CFU/100 mI |
| Enterococci presumptive | 0 | CFU/100 ml |
| Clostridium Perfringes, confirmed | 0 | CFU/100 ml |
| Clostridium Perfringes, presumptive | 0 | CFU/100 ml |
| Temperature, Filed on the day of testing | 21 | Cel. |

Additionally, the outlet alkaline water produced by the n-MSAP of the present invention has been nutritionally and chemically analysed by state of the art methods used for nutritional and chemical certificates. The nutritional and chemical certificates were issued by independent certified and accredited laboratories. The results of the nutritional and chemical certificates of the outlet alkaline water produced by bringing water purified by reverse osmosis (RO) filtration in contact with the reaction medium inside the AES modules as described by the n-MSAP above are as follows:

| Analysis | Result | Units |
|---|---|---|
| Energy | 0.0 | kJ/100 g |
| Calories | 0.0 | kJ/100 g |
| Moisture | 100 | g/100 g |
| Nitrogen | <0.02 | g/100 g |
| Protein (Nitrogen × 6.25) | <0.1 | g/100 g |
| Total Fat | <0.1 | g/100 g |
| Saturated Fat | <0.1 | g/100 g |
| Mono-unsaturated Fat | <0.1 | g/100 g |
| Poly-unsaturated Fat | <0.1 | g/100 g |
| Trans-unsaturated Fat | <0.1 | g/100 g |
| Available Carbohydrates | <0.1 | g/100 g |
| Total Sugar | <0.1 | g/100 g |
| Dietary Fibre (AOAC) | <0.5 | g/100 g |
| Ash | <0.1 | g/100 g |
| Sodium | <0.01 | g/100 g |
| Sodium expressed salt | <0.1 | g/100 g |

Following the delivery of the outlet alkaline water, from the apparatus of FIGS. 1-4 or of FIGS. 5 and 6, to the bottling plant's machinery, the outlet alkaline water is bottled/packaged under strict production and bottling/packaging conditions to produce bottled/packaged plain alkaline water with stable pH ranging from 7 to 11.

Additionally, the outlet alkaline water may be mixed with and/or blended in with drink formulations under strict production and bottling/packaging conditions at bottling line or drinks production facilities to produce drinks including, but not limited to, flavoured alkaline water, soft drinks, flavoured drinks, functional beverages, protein rich drinks, sports drinks, infusions, CBD or CBD and THC containing drinks.

Additionally, the outlet alkaline water may be mixed with and/or blended in with drink formulations under strict production and bottling/packaging conditions at bottling line or drinks production facilities to produce drinks with no or reduced added sugar and artificial sweeteners.

1. An apparatus for the treatment of water, the apparatus comprising a vessel having a water inlet and a water outlet, means for feeding water to the vessel via the water inlet, the vessel containing a body of water and a solid particulate or granular material comprising one or more elementary metals or oxides thereof capable of raising the pH of the water, and means, located within the vessel and connected to the water inlet, for causing circulatory motion of water entering the vessel sufficient to suspend the solid material within the body of water during passage of water through the vessel, whereby the pH of the water is caused to lie within the range 7 to 11.

2. The apparatus according to claim 1, wherein the means for causing circulatory motion increases the flow rate of water entering the vessel.

3. The apparatus according to claim 1, wherein the means for causing circulatory motion comprises a venturi effect inducing device.

4. The apparatus according to claim 1, wherein the means for causing circulatory motion further comprises a pipe extending to within the vessel.

5. The apparatus according to claim 1, wherein the means for causing circulatory motion comprises a venturi effect-inducing device connected to the inlet via connecting ribs and having a semi-rectangular shaped body, an upper vent and a lower vent and having a diameter of from 4.5 to 6.5 cm.

6. The apparatus according to claim 1, wherein the apparatus comprises a plurality of vessels as defined in claim 1.

7. The apparatus according to claim 1, wherein the material comprises up to 17 metals and/or their oxides.

8. Apparatus according to claim 1, wherein the material comprises oxides include one or more of the oxides of calcium, potassium, sodium, manganese, zinc, magnesium, germanium, iron, zinc, copper, chromium, cobalt, nickel, boron, vanadium, molybdenum and selenium.

9. The apparatus according to claim 1, wherein the flow rate through the vessel or each vessel is from 25 to 150 litres/min.

10. The apparatus according to claim 1, wherein the apparatus comprises one or more modules, each comprising an external tank for inlet feed water, a manual butterfly valve, an external pump for inlet feed water, an automatic butterfly valve, a vessel as defined in claim 1, a control panel, a filed control box, a modular diaphragmatic valve, a tank for outlet water, an external pump for outlet water, an external mounting framework, a media exchange box, and a filtration cartridge.

11. The apparatus according to claim 1, the apparatus comprising a plurality of vessels as defined in claim 1 and pipework that interconnects the vessels and connects them to the machinery of a bottling plant.

12. The apparatus according to claim 1, wherein the apparatus is provided with a plurality of performance and water quality probes which send data information by cables connected to a control panel via a field control box provided by a touch screen display screen that enables an operator to view the data information.

13. The apparatus according to claim 1, wherein the apparatus is provided with probes for water pH, conductivity, temperature, water pressure, water flow, water presence and water level gauges.

14. The apparatus according to claim 1, wherein the apparatus includes a control panel that is provided by a programmable logic controller (PLC) and software that is programmed with an algorithm that controls, maintains and adjusts the reaction conditions within the module by computing data information from the plurality of water quality probes as well as the amount of material used, the chemical and physical properties of the elements within the material, and the target desirable chemical and physical properties of the outlet water.

15. The apparatus according to claim 1, wherein the apparatus includes a control panel providing wireless feed to remote stations.

16. (canceled)

17. The apparatus according to claim 1, wherein the vessel is tubular in shape, manufactured of food grade materials, and attached into an external metal framework.

18. The apparatus according to claim 1, wherein the vessel has a footprint of approximately 1.5 m (L), 1.5 m (W) and 1.5 m (H).

19. The apparatus according to claim 1, wherein the vessel is elongate and provided at each end with an openable lid.

20. (canceled)

21. (canceled)

22. (canceled)

23. (canceled)

24. (canceled)

25. (canceled)

26. (canceled)

27. (canceled)

28. The apparatus according to claim 1, wherein the apparatus is provided with a media exchange box which interacts with the outlet alkaline water to activate and enhance the pH levels and also further clean and purify the outlet alkaline water by means of one or more internal enzymatic probes.

29. A method for the treatment of water to cause the pH of the water to lie within the range 7 to 11, the method comprising passing the water through apparatus as defined in claim 1.
